(19) United States
(12) Patent Application Publication
(10) Pub. No.: US 2006/0133829 A1
(43) Pub. Date: Jun. 22, 2006

(54) Image processing apparatus, image forming apparatus, and network image processing system

(75) Inventor: Atushi Kato, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,495

(22) Filed: Dec. 16, 2004

(51) Int. Cl. G03G 15/00; G03G 21/02

(52) U.S. Cl. 399/8; 399/79

(57) ABSTRACT

An image processing apparatus according to an aspect of this invention comprises an image processing unit which processes an image, a managing unit which manages history information about the image processing, and an output unit which outputs the history information of a general-purpose format.

### BACKGROUND OF THE INVENTION

1. Field of the Invention

This invention relates to an image processing apparatus capable of executing various kinds of image processing, an image forming apparatus capable of executing image formation, and a network image processing system in which the image processing apparatus and an administrative terminal device are connected via a network.

2. Description of the Related Art

Recently, a multi-functional printer (MFP) having a plurality of functions such as scanning, copying, printing and the like has appeared. The MFP can, for example, convert an office document into electronic form, and manage and utilize the electronic document. A paperless office can be thereby implemented. For example, the MFP can save document data taken by scanning or transmitted from a terminal via a network. The terminal connected to the MFP can instruct the MFP to print the document saved in the MFP.

It is very convenient for the user to use the MFP by a user's own terminal via the network. In response to this, an MFP administrator wishes to manage a usage history of the MFP with good efficiency. If the usage history information is stored in the MFP, the administrator needs to visit an installation place of the MFP to check the usage history information. In addition, the manager may not be able to read the usage history due to a trouble of the MFP.

### BRIEF SUMMARY OF THE INVENTION

The object of the present invention is to provide an image processing apparatus, an image forming apparatus and a network image processing system, excellent in managing the usage history information.

An image processing apparatus according to an aspect of this invention comprises an image processing unit which processes an image, a managing unit which manages history information about the image processing, and an output unit which outputs the history information of a general-purpose format.

An image forming apparatus according to an aspect of this invention comprises an image forming unit which forms an image, a managing unit which manages history information about the image formation, and an output unit which outputs the history information of a general-purpose format.

In a network image processing system according to an aspect of this invention, an image processing apparatus and an administrative terminal device are connected via a network. The image processing apparatus comprises an image processing unit which processes an image, a first managing unit which manages history information about the image processing, a first output unit which outputs the history information of a general-purpose format to the administrative terminal device, and a first input unit which inputs the history information of the general-purpose format from the administrative terminal device. The administrative terminal device comprises a second input unit which inputs the history information of the general-purpose format from the image processing apparatus, a second managing unit which manages the history information of the general-purpose format, and a second output unit which outputs the history information of the general-purpose format to the image processing apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a network image processing system;

FIG. 2 is a diagram schematically showing a multifunctional printer (MFP) and an administrative terminal device in the network image processing system;

FIG. 3 is a flowchart showing management of history information;

FIG. 4 is a flowchart showing restoration of the history information on the MFP side;

FIG. 5 is an illustration showing an example of the history information in a CSV format;

FIG. 6 is a diagram showing an example of managing a plurality of MFPs 1 by a single administrative terminal device 2;

FIG. 7 is a diagram showing an example of managing the single MFP 1 by a plurality of administrative terminal devices 2;

FIG. 8 is a diagram showing an example of managing a plurality of MFPs 1 by a plurality of administrative terminal devices 2; and

FIG. 9 is a diagram showing an example of transferring history information of a predetermined MFP 1 to another MFP 1.

### DETAILED DESCRIPTION OF THE INVENTION

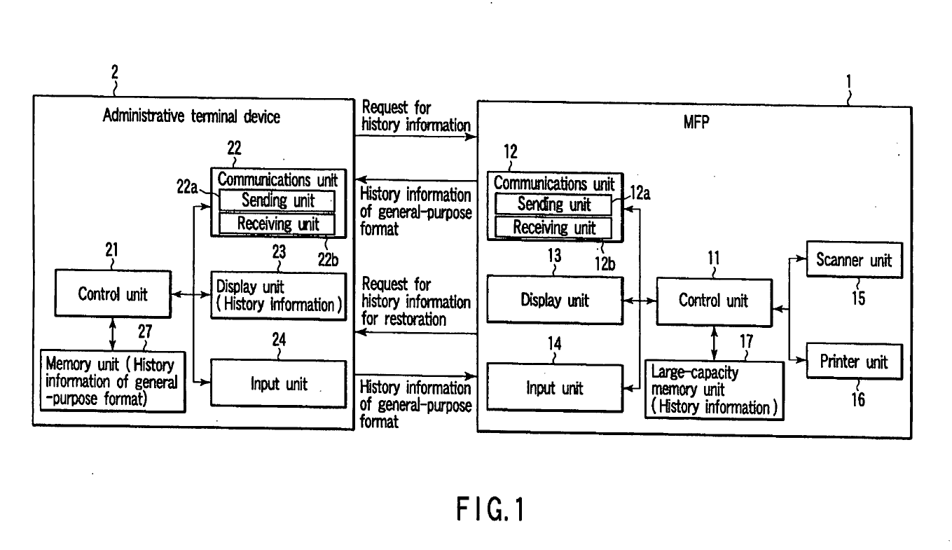

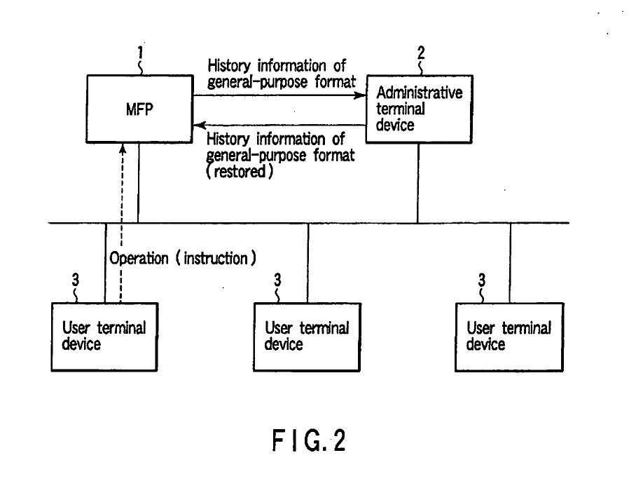

FIG. 1 is a block diagram showing a network image processing system. FIG. 2 is a diagram schematically showing a multifunctional printer (MFP) and an administrative terminal device in the network image processing system.

As shown in FIG. 1, for example, the network image processing system comprises an MFP 1 according to an example of an image processing apparatus or an image forming apparatus, an administrative terminal device 2, and a plurality of user terminal devices 3. They are connected via a network. In the system shown in FIG. 1, the single MFP 1 and the single administrative terminal device 2 are connected. However, a plurality of MFPs 1 and the single administrative terminal device 2 may be connected via the network or the single MFP 1 and a plurality of administrative terminal devices 2 may be connected via the network. Moreover, a plurality of MFPs 1 and a plurality of administrative terminal devices 2 may be connected via the network.

As shown in FIG. 2, for example, the MFP 1 comprises a control unit 11, a communications unit 12, a display unit 13, an input unit 14, a scanner unit 15, a printer unit 16 and a large-capacity memory unit 17. The administrative terminal device 2 is, for example, a personal computer (PC), comprising a control unit 21, a communications unit 22, a display unit 23, an input unit 24 and a memory unit 27. The communications unit 12 of the MFP 1 includes a sending unit 12a and a receiving unit 12b. The communications unit 22 of the administrative terminal device 2 includes a sending unit 22a and a receiving unit 22b. The communications unit 12 of the MFP 1 and the communications unit 22 of the administrative terminal device 2 are connected via the network. Sending and receiving various kinds of data can be thereby executed between the MFP 1 and the administrative terminal device 2.

The scanner unit 15 of the MFP 1 optically scans a document, and sends data of the scanned document to the large-capacity memory unit 17. The printer unit 16 reads and prints the document data stored in the large-capacity memory unit 17. The large-capacity memory unit 17 stores the document data sent from the scanner unit 15 or document data sent from the administrative terminal device 2 connected via the network. The display unit 13 displays necessary information (various parameters and instructions) about the scanning function of the scanner unit 15, the printing function of the printer unit 16 and the copying function of the scanner unit 15 and the printer unit 16. The input unit 14 inputs the necessary information (various parameters and instructions) about the scanning function of the scanner unit 15, the printing function of the printer unit 16 and the copying function of the scanner unit 15 and the printer unit 16. The control unit 11 controls the operations of the scanning function, the printing function and the copying function on the basis of the information input from the input unit 14. The display unit 13 and the input unit 14 may be combined as a touch panel.

The large-capacity memory unit 17 stores history information about the image processing in addition to the above-explained document data. For example, the control unit 11 of the MFP 1 controls the image processing operation under a condition of inputting an identification code. In other words, the MFP 1 is not operated without inputting the identification code. A record of the history information includes the identification code and concrete contents of the image processing. The concrete contents of the image processing include the date and time of the image processing (starting date and time/ending date and time), the number of processed images (counter information), the size of the processed images, and the like. For example, the usage history of the MFP 1 in each section can be managed by setting the identification code corresponding to each section in the office.

The control unit 11 converts the history information of a predetermined formant (for example, format inherent to the MFP) stored in the large-capacity memory unit 17 into the history information of a general-purpose formant. In response to a request from the administrative terminal device 2, the control unit 11 sends the history information of the general-purpose formant to the administrative terminal device 2 via the sending unit 12a of the communications unit 12. The general-purpose formant is, for example, CSV (Comma Separated Value) format.

The control unit 21 of the administrative terminal device 2 requests the history information to the MPF 1, receives the history information from the MPF 1, and sends the history information to the MPF 1, via the communications unit 22. The memory unit 27 stores the history information from the MPF 1. The input unit 24 is, for example, a keyboard, accepting input of various kinds of instructions to the control unit 21.

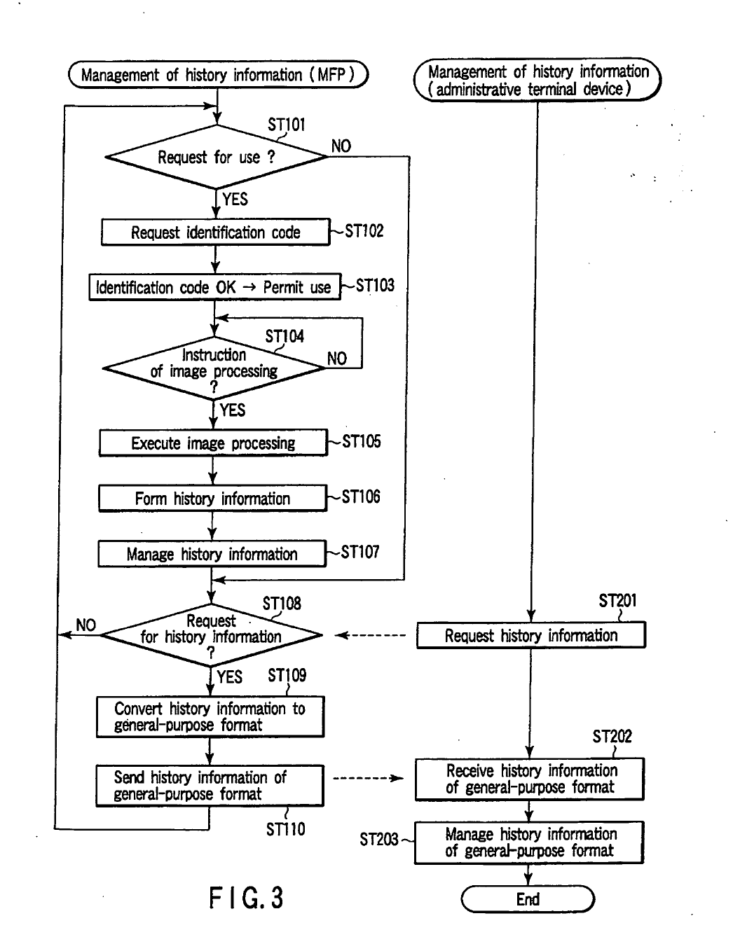

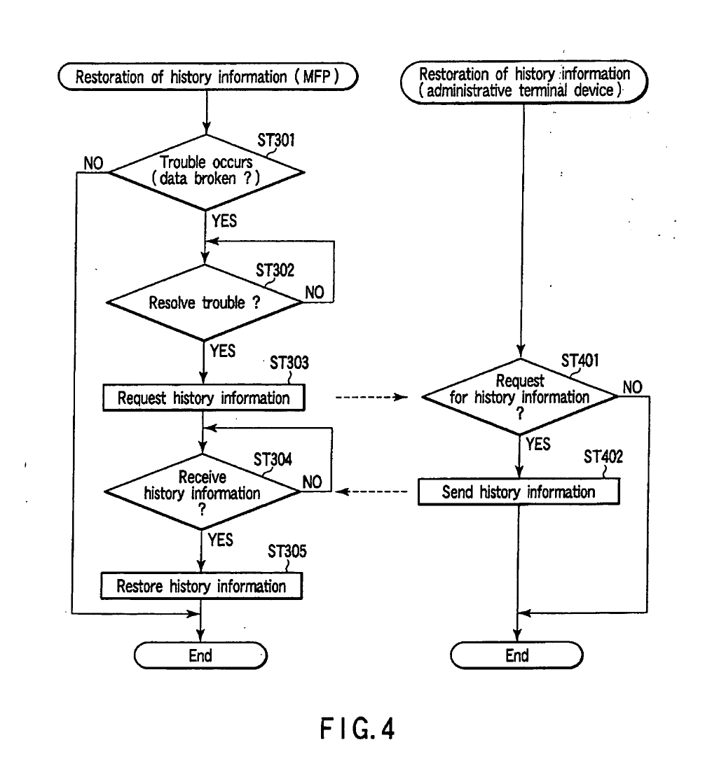

Next, management to restoration of the history information will be explained with reference to FIGS. 3 to 4. FIG. 3 is a flowchart showing the management of the history information. FIG. 4 is a flowchart showing the restoration of the history information on the MFP side.

If the MFP 1 (control unit 11) receives a request for use from the user terminal device 3 via the network (ST101, YES), the MFP 1 (control unit 11) requests the user terminal device 3 to send an identification code thereof (ST102). The MFP 1 (control unit 11) receives the identification code input on the user terminal device 3, discriminates correctness of the received identification code, and permits the use (ST103).

The MFP 1 (printer unit 16) receives an instruction for image processing operation (instruction for printing or the like) from the user terminal device 3 (ST104, YES) and executes the image processing operation (printing or the like) (ST105). Together with the image processing operation, the above-explained history information (1 record) is formed by a Web managing function of the MFP 1 (control unit 11) (ST106). The formed history information is stored in the large-capacity memory unit 17 and then managed (ST107).

The administrative terminal device 2 requests the history information as occasion requires (ST201). For example, if a Web administrator managing the Web wishes to confirm the history information, the Web administrator requests the history information via the administrative terminal device 2. Otherwise, the Web administrator requests the history information via the administrative terminal device 2 to back up the history information.

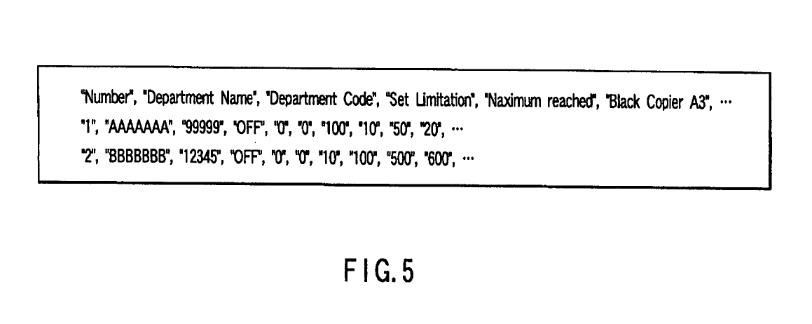

If the MFP 1 (control unit 11) receives a request for the history information (request for usage, request for backup, or the like) from the administrative terminal device 2 (ST108, YES), the MFP 1 (control unit 11) converts the history information of the predetermined format (for example, the formant inherent for the MFP) stored in the large-capacity memory unit 17 into the history information of the general-purpose format (for example, the CSV format) (ST109) and sends the history information of the general-purpose format to the administrative terminal device 2 (ST110). FIG. 5 is an illustration showing an example of the converted history information of the CSV format.

The administrative terminal device 2 receives the history information of the general-purpose format from the MFP 1 (ST202), and stores and manages the history information in the memory unit 27 (ST203). Without new investment in equipment on the administrative terminal device 2 side, the history information stored in the memory unit 27 can be reproduced and displayed by the general-purpose existing application of the administrative terminal device 2 side. The history information stored in the memory unit 27 can also be utilized as backup information. For example, since the history information includes the identification code assigned to each of the sections, the information indicating the section to which the identification code is assigned can also be backed up. Moreover, the history information of the general-purpose format can be converted into a format which can be managed more easily, and can be utilized by the administrative terminal device 2. Thus, the history information formed and managed on the MFP 1 side (i.e. the history information of each section) can be acquired in the general-purpose format and the Web administrator managing the Web can easily confirm the MFP usage conditions of each section.

Next, restoration of the history information will be explained. For example, the history information data stored in the large-capacity memory unit 17 is broken due to a trouble in the MPF 1 as shown in FIG. 4 (ST301). Specifically, the history information data is broken since the power supply to the MPF 1 is shut down during the operation of the MPF 1 or the large-capacity memory unit 17 is physically broken. In this case, if the trouble in the MPF 1 is resolved by restart of the power supply to the MPF 1, exchange of the large-capacity memory unit 17, or the like (ST302, YES), restoration of the history information is executed.

First, the MPF 1 requests the history information to the administrative terminal device 2 (ST303). If the administrative terminal device 2 receives the request for the history information from the MPF 1 (ST401, YES), the administrative terminal device 2 reads the history information stored in the memory unit 27 and the sends the history information to the MPF 1 (ST402). The MPF 1 receives the history information sent from the administrative terminal device 2 (ST304, YES). The management information is updated on the basis of the received history information. The broken history information is thereby restored to the original history information (ST305). If the large-capacity memory unit 17 is exchanged, the received history information is stored in the large-capacity memory unit 17 as it is. By such restoration, turnaround of recovery from the trouble on the MFP 1 side can be thereby accelerated.

The control unit 11 of the MFP 1 may control the recovering operation of prohibiting acceptance of the image processing in response to the occurrence of the trouble and automatically restarting the acceptance of the image processing in accordance with completion of the restoration. The MFP administrator's labor for the recovering operation can be thereby saved.

Usability can be improved by the management of the history information (i.e. export of the history information) and the restoration of the history information (i.e. import of the history information) based on the above-described Web management function.

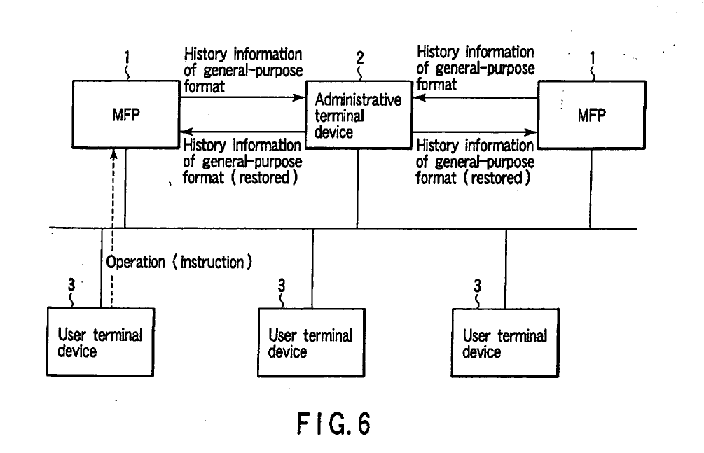

Next, applied examples will be explained with reference to FIG. 6 to FIG. 9.

FIG. 6 is a diagram showing an example of managing a plurality of MFPs 1 by the single administrative terminal device 2. In other words, each of the MFPs 1 is operated on the basis of the image processing instructions from the respective user terminal devices 3. Each of the MFPs 1 manages the history information. The administrative terminal device 2 receives the history information of each of the MFPs 1 and centralizes the management of the history information. The Web administrator can thereby centralize the management of each of the MFPs 1 by the administrative terminal device 2. In addition, the Web administrator can back up the history information of each of the MFPs 1 by the administrative terminal device 2 and reduce the installation cost of the administrative terminal device 2.

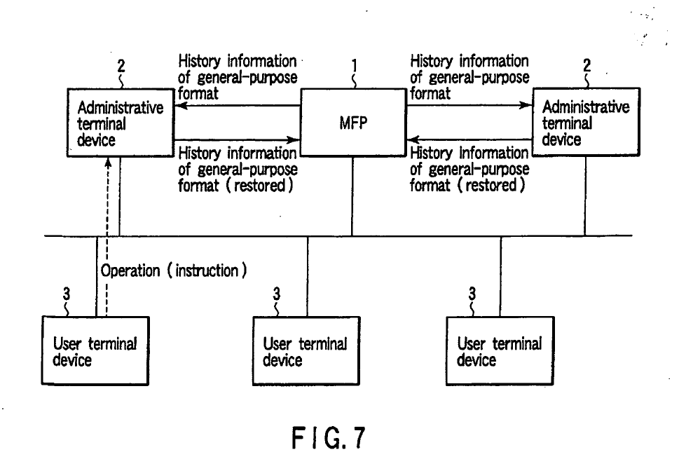

FIG. 7 is a diagram showing an example of managing the single MFP 1 by a plurality of administrative terminal devices 2. In other words, the MFP 1 is operated on the basis of the image processing instructions from the respective user terminal devices 3. The MFP 1 manages the history information. The administrative terminal devices 2 receive the history information of the MFP 1 and multiplex the management of the history information. The history information can be thereby backed up with safety.

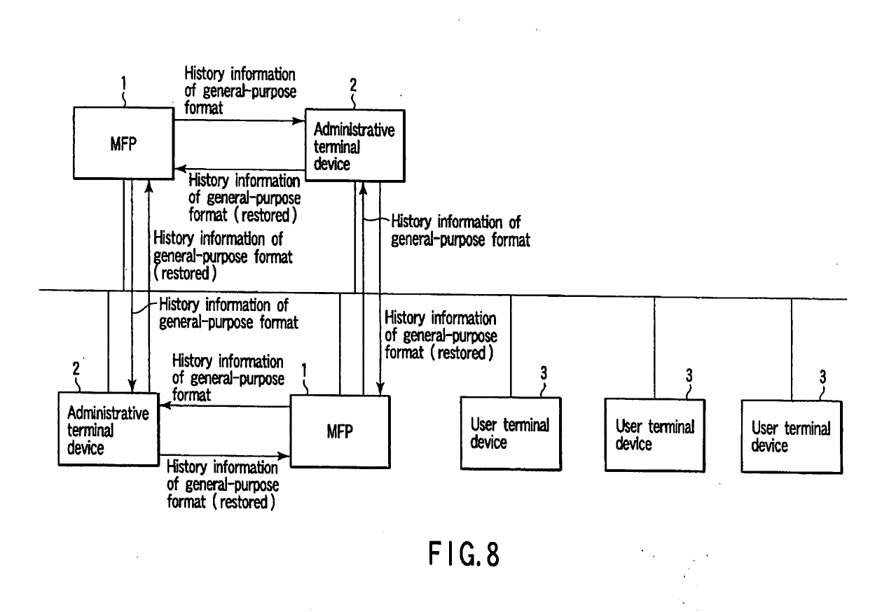

FIG. 8 is a diagram showing an example of managing a plurality of MFPs 1 by a plurality of administrative terminal devices 2. In other words, each of the MFPs 1 is operated on the basis of the image processing instructions from the respective user terminal devices 3. Each of the MFPs 1 manages the history information. The administrative terminal devices 2 receive the history information of each of the MFPs 1 and centralize the management of the history information. The Web administrator can thereby centralize the management of the operation of each of the MFPs 1 by any one of the administrative terminal devices 2. For example, a plurality of Web administrators at a plurality of places can simultaneously manage the operation of each of the MFPs 1. In addition, the administrative terminal devices 2 can receive the history information of the MFPs 1 and multiplex the management of the history information. The history information can be thereby backed up with safety.

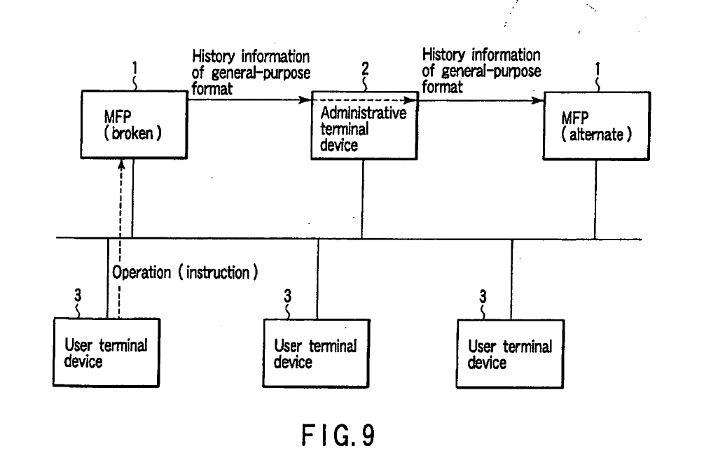

FIG. 9 is a diagram showing an example of transferring history information of a predetermined MFP 1 to another MFP 1. For example, if the history information of a predetermined MFP 1 is managed by one or plural administrative terminal devices 2 as shown in FIG. 1 and FIGS. 6 to 8 and the MFP 1 is exchanged with a new MFP 1 (alternate), the history information of the predetermined MFP 1 managed by the administrative terminal device 2 is transferred to the new MFP 1. The history information of the MFP 1 causing a trouble can be thereby reflected on the new MFP 1. In other words, the history of the image processing of the MFP 1 causing a trouble and the history of the image processing of the new MFP 1 can be managed as the history of the image processing of the identical MFP 1.

In addition, even when the entire information in the predetermined MFP 1 is not only transferred to the alternate MFP, but the large-capacity memory unit 17 (for example, a hard disk) alone of the predetermined MFP 1 is also exchanged to a new memory unit, the history information of the predetermined MFP 1 managed by the administrative terminal device 2 can be utilized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image processing apparatus comprising:
a first image processing unit which processes an image;
a first managing unit which manages history information about the image processing; and
a first output unit which outputs the history information of a general-purpose format;
a first input unit which inputs the history information of the general-purpose format
wherein the first managing unit repairs damaged history information using the history information input by the input unit.

2. (canceled)

3. The apparatus according to claim 1, wherein the first managing unit updates the history information managed by the first managing unit in accordance with the history information input by the input unit.

4. (canceled)

5. The apparatus according to claim 1, wherein the history information includes counter information acquired by counting number of the image processing.

6. The apparatus according to claim 5, wherein the history information includes the counter information managed in accordance with identification codes.

7. An image forming apparatus comprising:
an image forming unit which forms an image;
a managing unit which manages history information about the image formation;
an output unit which outputs the history information of a general-purpose format; and
an input unit which inputs the history information of the general-purpose format;
wherein the managing unit repairs damaged history information using the history information input by the input unit.

8. (canceled)

9. The apparatus according to claim 7, wherein the managing unit updates the history information managed by the managing unit in accordance with the history information input by the input unit.

10. (canceled)

11. The apparatus according to claim 7, wherein the history information includes counter information acquired by counting number of the image processing.

12. The apparatus according to claim 12, wherein the history information includes the counter information managed in accordance with identification codes.

13. A network image processing system in which the image processing apparatus of claim 1 and an administrative terminal device are connected via a network,
the administrative terminal device comprising:
a second input unit which inputs the history information of the general-purpose format from the image processing apparatus;
a second managing unit which manages the history information of the general-purpose format; and
a second output unit which outputs the history information of the general-purpose format to the image processing apparatus.

14-15. (canceled)

16. The apparatus according to claim 1 wherein damage to the history information is caused by a power loss during operation of the image processing apparatus.

17. The apparatus according to claim 4, further comprising a large-capacity memory unit which stores the history information, and wherein damage to the history information is caused by a physical break in the large-capacity memory unit.

18. A process for operating an apparatus whose main operation is processing images or forming images, the process comprising
generating history information about the main operation of processing images or forming images
storing the history information in a large-capacity memory
managing the history information within the large-capacity memory
outputting the history information through an output unit
the history information in the large-capacity memory becoming damaged
receiving history information through an input unit
repairing the damaged history information using the history information input from the input unit.

19. The process for operating an apparatus of claim 18 further comprising
updating the history information in the large-scale memory with the history information received from the input unit.

20. The process for operating an apparatus of claim 18
wherein the history information includes counter information acquired by counting a number of the main operation

21. The process for operating an apparatus of claim 20
wherein the history information includes identification codes correlated to the counter information.

22. The process of claim 18 embodied as a computer program product stored in a tangible medium for causing the apparatus to perform the steps comprising the process.
